(19) United States
(12) Patent Application Publication
(10) Pub. No.: US 2020/0215508 A1
(43) Pub. Date: Jul. 9, 2020

(54) LOADING OF SOLID PARTICLES INTO A VESSEL

(71) Applicant: PETROVAL, Saint Romain De Colbosc (FR)

(72) Inventors: Olivier GIRARD, Abjat Sur Bandiat (FR); François GUERRAND, Le Havre (FR); Adriaan STANDER, Fontenay (FR); Giuseppe GALASSINI, Marino Rome (IT)

(73) Assignee: PETROVAL, Saint Romain De Colbosc (FR)

(21) Appl. No.: 16/734,070

(22) Filed: Jan. 3, 2020

(30) Foreign Application Priority Data
Jan. 4, 2019 (FR) 1900052

(51) Int. Cl. B01J 8/00

(52) U.S. Cl. CPC B01J 8/0045; B01J 2208/00752; B01J 2208/00938

(57) ABSTRACT

A device for distribution of solid particles for loading a vessel with solid particles, comprising: a solid particle feed hopper, a rotating member and a drive member coupled to said rotating member to drive in rotation said rotating member, a set of at least one deflector element, each deflector element extending in its longitudinal direction between a first end and a second end, and being carried by said rotating member at its first end, where, at least one deflector element of said set is rigid and mounted to pivot on the rotating member at its first end, the device further comprises remotely actuatable deployment means adapted to drive at least one deflector element mounted to pivot on the rotating member so as to cause it to pivot from a position for introduction into the vessel to an erected, particle deviation position independent of the rotation speed of the rotating member.

### CROSS-REFERENCE TO RELATED APPLICATIONS

This application claims priority to, and benefit of, French application no. 1900052, filed Jan. 4, 2019 with the Institut National de la Propriété Industrielle (French patent office), which is hereby incorporated by reference.

### BACKGROUND

The invention concerns the distribution of solid particles into a vessel, and in particular into a reactor.

It is known to load reactors, in particular of chemical, electrochemical, petroleum or petrochemical type, with solid particles in the divided state. These particles may for example take the form of balls, grains, cylinders, pastilles, batons or any other shape and generally have relatively small dimensions.

The particles may in particular be grains of solid catalysts, generally extruded and produced either with a regular shape or in the shape of single-lobe or multilobe batons, the dimensions of which may vary with circumstances from a few tenths of a millimeter to a few centimeters.

The aim is to load a large number of solid particles homogeneously and as uniformly as possible into a restricted space in a short time period.

It is this application, termed “dense loading”, of grains of catalysts into a chemical reactor that will be more particularly referred to in the remainder of the present description. By “dense loading” is meant here loading by a rainfall effect effected so as to reconcile restricted space, short loading time, high density, homogeneity and uniformity.

However, the device described may more generally find applications in the context of loading solid particles into a reactor or other cylindrical vessel.

Several methods and devices enabling the density of a fixed bed of particles of catalyst in a chemical reactor to be increased are already known.

Document WO 2010/076522 (Cottard et al.) may for example be cited. The device described, comprising a rotating shaft and deflector elements, is advantageous in the sense that it can be introduced into the reactor via an orifice of relatively small section, the semi-rigid deflector elements then being erected upon rotation of the rotating member.

Devices of the type described in the document WO 2010/076522 have in common the introduction of particles to be loaded via the top of the reactor and collision of the individual particles, as they fall, with fixed or mobile mechanical deflectors, causing a random deviation of said particles. The particles deviated in this way from falling vertically then ideally fall individually and freely with a rainfall effect onto the whole of the surface of the filling front, where they form a dense and homogeneous deposit.

The distribution device is conventionally installed in a filling opening of the reactor situated at the top of the reactor and at the center of the reactor.

However, the installation in the reactor of this kind of distribution system, in particular including the distribution device and the probe supports, may be relatively difficult to carry out, in particular because of the dust generated.

It may further be difficult to close the reactor in complete safety.

For these environmental and operating safety reasons, and sometimes for other reasons depending on the applications, the Applicant has therefore envisaged limiting the diameter of the orifice for introduction of the loading device.

Producing the straps in a more flexible material could be envisaged to limit the overall size during introduction of the device, but there is then a risk of loading being unsatisfactory failing effective distribution of the solid particles.

There is therefore a need for a solid particle distribution system adapted to be introduced into the reactor via an orifice of relatively small section whilst ensuring relatively dense loading.

### SUMMARY

There is proposed a device for distributing solid particles for loading a vessel, for example a reactor, with solid particles, comprising:
a solid particle feed hopper defining a set of at least one opening for evacuation of particles from the hopper by gravity,
a rotating member and a drive member coupled to said rotating member to drive said rotating member in rotation about a rotation axis having under conditions of use a direction with a component in the direction of the gravity vector, for example a rotation axis parallel to the gravity vector,
downstream of the set of at least one opening of the feed hopper a set of at least one deflector element, each deflector element extending along its longitudinal direction between a first end and a second end and being carried by said rotating member at its first end.

According to the invention:
at least one (and preferably each) deflector element of said set is rigid and mounted to pivot on the rotating member at its first end,
the distribution device further comprises remotely actuatable deployment means adapted to drive at least one deflector element mounted to pivot on the rotating member so as to cause it to pivot from a position for introduction into the vessel, in which its longitudinal direction forms a first angle with the direction of the rotation axis, to a particle deviation position, in which its longitudinal direction forms a second angle with the direction of the rotation axis, the second angle being strictly greater than the first angle and imposed by the deployment means independently of the rotation speed of said rotating member.

Accordingly, rather than flexible or semi-rigid straps the end of which is rigidly fixed to the rotating member, which are relatively bulky when the rotation speed is zero, there are provided at least one rigid deflector element, at least one articulated connection between the first end of said rigid deflector element and said rotating member and means for deployment of said deflector element. By actuating these deployment means, this at least one deflector element can be caused to pivot when it is already inside the vessel so as to move the second end away from the rotation axis.

The distribution device described hereinabove is moreover advantageous in the sense that in operation the rotation speed has no effect on the angle between this at least one deflector element and the rotation axis. In other words, that angle is imposed via the deployment means, independently of the angular speed. In particular this angle can be adjusted including in the absence of any rotation. In other words, the deployment means are totally independent of and separate from the motor. This enables better control of loading in that the rotation speed influences fewer parameters, a priori only the level of rebounds of the falling particles (by an abuse of language this is referred to as permeability).

The set of at least one deflector element may comprise a single deflector element or may advantageously comprise a plurality of deflector elements that may be different lengths.

In this latter case the deployment means may be adapted to cause all the deflector elements of said plurality to pivot, advantageously simultaneously.

Alternatively, the deployment means may be conformed to cause one or more deflector elements to pivot independently of the other deflector elements of said plurality.

The loading device may further comprise a set of at least one supplementary deflector element independent of the deployment means. This set of at least one supplementary deflector element may for example be erected by the centrifugal force generated by the rotation of the rotating member.

In one embodiment the distribution device may be such that said at least one deflector element mounted to pivot may, when the rotation speed of the rotating member is zero and the rotation axis is vertical, have only two equilibrium positions, corresponding to the first and second angles. In other words, the deployment means are able to maintain said at least one deflector element mounted to pivot erected at only one angular position.

In another embodiment, the distribution device may be such that the deployment means are able to retain said at least one deflector element mounted to pivot in at least one intermediate position, each intermediate position corresponding to an angle strictly greater than the first angle and strictly less than the second angle. In other words, the deployment means can enable adjustment of the angle between said at least one deflector element mounted to pivot and the rotation axis, thus enabling even better control of loading.

According to the invention at least one deflector element is rigid. The invention therefore enables reconciliation of compactness during introduction of the set of at least one deflector element and loading quality, because the particles are able to rebound relatively far.

However, there is nothing to exclude further providing at least one deflector element, and possibly a plurality of deflector elements, made of semi-rigid or flexible material.

In one embodiment there can further be at least one deflector element that is rigid at the first end and more flexible at the second end. This more flexible part can procure a whip effect when this deflector element is driven in rotation sufficiently rapidly.

For example, at least one deflector element may be produced from a rigid material over two thirds of the length and a flexible material over the remaining third, at its free end.

By “remotely actuatable” is meant actuatable from outside the vessel. The deployment means may for example cooperate with a mechanical element, for example a rod, a part of which may still be outside the vessel when the set of deflector element or elements is inside it. In another embodiment, the deployment means may comprise wireless receiving means for receiving control messages sent by sending means situated outside the vessel.

For example, the deployment means may comprise at least one stepper motor, a microcontroller for controlling that motor, and wireless receiving means.

In accordance with another example, advantageous in terms of robustness, the deployment means may comprise a linkage member comprising a first rod extending toward the hopper top (under conditions of use), advantageously over a sufficient height to enable its manipulation from outside the vessel when the or each deflector element is received in the vessel and at least one second rod mounted on and articulated relative to the first rod (either directly or via other elements) and cooperating with at least one deflector element.

A linkage member comprises a plurality of rods articulated to one another and thus by manipulating one of those rods, referred to as the first rod, from outside the vessel, at least one other rod may be driven in movement, and in fine, at least one deflector element.

The difference between the first angle and the second angle may advantageously be greater than or equal to 30°, advantageously greater than or equal to 60°.

The difference between the first angle and the second angle may advantageously be less than or equal to 100°, advantageously less than or equal to 95° or 90°.

The first angle may advantageously be between 0° and 40° or 30° inclusive, advantageously between 0° and 20° inclusive. For example the first angle may be between 0° and 5° inclusive.

The second angle may advantageously be between 45° and 100° inclusive, advantageously between 60 and 95° inclusive. For example the second angle may be between 75° and 90° inclusive.

In one embodiment, the set of at least one opening of the feed hopper may be conformed in any asymmetric manner relative to the rotation axis, defining at most one plane of symmetry passing through the rotation axis.

This set of at least one opening may be conformed so that, for at least one plane normal to the rotation axis and situated under the set of at least one opening (advantageously between that set of at least one opening and the set of at least one deflector element), the flow rate of particles falling through a first angular sector in said plane and the apex of which is on the rotation axis is strictly greater than the flow rate of particles falling through a second angular sector in that plane and the apex of which is on the rotation axis, the first and second sectors having the same angle value and being separate.

The distribution being asymmetric, this device could be disposed in an eccentric manner in the vessel without this prejudicing the quality of loading.

In one embodiment the loading device may be such that the rotating member has a continuous movement at constant rotation speed over a plurality of turns.

Alternatively, the drive member may be such that the rotating member to which it is coupled effects a movement with variations of angular speed over an angular range of 360° or less, for example an oscillating movement, with changes of rotation direction.

The set of at least one deflector element may be distributed in a regular manner around the rotation axis or in an irregular manner.

For example, the set of at least one deflector element may be such that when erected relative to the rotation axis the projections of said set in a plane normal to the rotation axis of the rotating member have an asymmetric distribution around said rotation axis with at most one plane of symmetry passing through the rotation axis.

Alternatively, the set of at least one deflector element may be such that when erected relative to the rotation axis the projections of said set in a plane normal to the rotation axis of the rotating member have a distribution with at least two planes of symmetry passing through the rotation axis.

Moreover, the set of at least one opening of the feed hopper may be conformed in an asymmetric manner relative to the rotation axis, defining at most one plane of symmetry passing through the rotation axis.

Alternatively, the set of at least one opening of the feed hopper may be conformed in a symmetrical manner relative to the rotation axis, defining at least two planes of symmetry passing through the rotation axis.

When the loading device has such asymmetries, there may be provision for offsetting it relative to a central vertical axis of the vessel, thus enabling space to be freed up for other equipment, in particular sensors. The distribution device may therefore be used to load vessels of small diameter.

By further providing rotation speeds over a short angular range, since an oscillating to-and-fro movement imposes passages through zero rotation speeds, there are favoured the deviations of the particles over the angular range over which the deflector elements are the most present.

On the other hand, a distribution device with a set of at least one opening of the feed hopper and a set of at least one deflector element that are regularly distributed could advantageously be installed on a vertical central axis of the vessel.

Each deflector element may for example occupy an angular range between 1° and 30°, advantageously between 5° and 20°, for example of the order of 10°.

In the case of an asymmetrical distribution device intended to be installed at an eccentric position the deflector elements may be distributed over only a restricted angular range, for example a range extending over less than 320°, advantageously over less than 280°, 180° or 120°, but advantageously over more than 5°.

The deflector elements may optionally be regularly distributed within this restricted angular range, or not.

The deflector elements distributed over this restricted angular range may be optionally made of identical materials, or not.

The deflector elements distributed over this restricted angular range may optionally have a length (in the radial direction) identical.

The plurality of deflector elements may advantageously comprise at least one short deflector element and at least one long deflector element, each long deflector element having a length in the radial direction greater than the length of a short deflector element.

In one embodiment the plurality of deflector elements distributed only over the restricted angular range may comprise two short deflector elements at respective ends of that restricted angular range and at least one long deflector element between those two short deflector elements.

In another embodiment there may be between four and twelve deflector elements distributed over 360°. For example, the set of deflector elements may comprise deflector elements of varying length.

The invention is not limited to a particular form of deflector elements.

The deflector elements may for example be made of rigid plastic, for example PVC (polyvinyl chloride), rubber, reinforced rubber or other material.

In particular an aluminum core and a rubber coating or matrix could be provided.

In the case of an oscillating movement, this kind of to-and-fro movement may advantageously be periodic, i.e. the movement may be identical for several seconds, advantageously for several minutes.

The period may be of the order of a few fractions of a second, for example of the order of one hundredth or one tenth of a second, or of the order of one second for example.

In the case of a movement with a variable rotation speed the drive member may comprise a motor controlled to effect a movement with angular speed variations over an angular range of 360° or less, for example an oscillating movement. The device may then comprise processing means, of the microcontroller type for example, for controlling the motor.

The drive member may comprise an electric motor, for example a stepper motor.

The processing means for controlling the electric motor may be programmed to control the electric motor in such a way as to impose an oscillating movement on it. These processing means may be on the motor or remain outside the reactor.

In another embodiment the drive member may comprise a motor controlled to effect a continuous rotation movement, for example an electric or other motor, and elements for conversion of the continuous rotation movement of the motor into a movement with angular speed variations over an angular range of 360° or less, for example an oscillating movement limited to an angular range of 360° or less, advantageously 350° or less. These conversion elements may cooperate on the one hand with the motor and on the other hand with the rotating member. These conversion elements may for example comprise a roller, a cam or other elements cooperating with a shaft of the motor and with the rotating member.

In particular the conversion elements may comprise an eccentric roller with an offset lug having at its end a pin positioned in an opening so as to transform the rotary movement into an oscillating movement, in the manner of a pendulum clock.

The drive member may comprise a pneumatic motor with a mechanical movement.

In the case of a distribution device with no asymmetries, the rotating member may for example be in one piece with the rotor of a motor. Of course elements could also be provided between the motor and the rotating member, for example gears, for example elements transforming the continuous rotation movement of the motor into another continuous rotation movement.

The rotation axis and the feed hopper may optionally be coaxial or not. In particular, in the case of a set of at least one asymmetric opening there may be provided a rotation axis offset relative to the opening or openings of that set.

The distribution device may comprise a rotating shaft cooperating with or in one piece with the drive member and/or the rotating member.

This shaft may be optionally received in the feed hopper. For example there could be provided a feed hopper slightly offset relative to the shaft.

The deflector elements may optionally be fixed to one another at different heights, for example at different levels.

In the case of deflector elements distributed over a plurality of levels, a quincunx distribution could optionally be provided from one level to the other.

There is also proposed an assembly comprising a vessel and a device as described hereinabove with the rotating member and the set of at least one deflector element introduced into the vessel.

In one embodiment, the vessel defining a central vertical axis when placed on a horizontal floor, the device as described above may optionally be installed in said vessel at an eccentric location relative to said central vertical axis.

The vessel may be a reactor, for example of chemical, petrochemical, electrochemical, petroleum or other type.

The reactor may be adapted to contain reagents and products of a catalytic reaction during that reaction. A catalytic reactor is then referred to.

The vessel may have in its upper part an orifice of the same diameter as a maximum diameter of the vessel, or advantageously of smaller diameter.

The maximum diameter of the vessel may be of the order of a few metres or alternatively of the order of one metre or less.

The diameter of the orifice may for example be of the order of a few metres, one metre or one decimeter.

There is further proposed a method of installing a solid particle distribution device as described hereinabove in a vessel, for example a reactor, defining an orifice in its upper part, in which:
at least the rotating member and the set of at least one deflector element comprising at least one rigid deflector element in a position for introduction into the vessel via said orifice are caused to pass through said orifice, and
the deployment means are remotely actuated to drive at least one deflector element mounted to pivot on the rotating member so as to cause it to pivot from the position for introduction into the vessel to the position for deviation of the particles.

In one embodiment this orifice may have relatively small dimensions, for example of the order of one decimeter, and/or be eccentric.

The invention finally consists in a method of loading solid particles into a vessel, preferably a catalytic reactor. Said method comprises:
a) the installation in the vessel of a distribution device as described above via an opening of the vessel defined in its upper part; then
b) driving in rotation the rotating member of said device; and
c) loading particles by introducing them into the feed hopper of the device while the rotating member continues to rotate.

In accordance with one preferred embodiment, the rotating member effects an oscillating movement (that is to say a to-and-fro movement) with the rotation direction reversed at the ends of an angular range extending over 350° or less, preferably 330° or less, more preferably 320° or less, better 310° or less, and even better 270° or less.

In the present application the terms “high”, “low”, “upper”, “lower”, “vertical”, “horizontal”, “lateral”, “above”, “below”, etc. are defined in the standard sense of those terms (that is to say the vertical direction is the direction of the gravity vector, that gravity vector being oriented downwards), for a vessel placed under normal conditions of use, that is to say with its longitudinal axis oriented in the direction of the gravity vector. Of course, the claimed subject matter can be oriented differently, in particular during its transportation.

As a general rule, in the present application by “one” is meant “one or more”.

In particular, the invention can find an application in reactors with small dimensions, for example a height of a few tens of centimeters and with an opening a few centimeters in diameter.

The invention is not limited to that application, however. For example a reactor could be several meters high and several meters in diameter.

### BRIEF DESCRIPTION OF THE DRAWINGS

The invention will be better understood with reference to the figures, which show nonlimiting embodiments.

FIG. 1 represents diagrammatically an assembly comprising a reactor and one example of a prior art solid particle distribution device.

FIG. 2 is a diagrammatic perspective view of a part of one example of a solid particle distribution device according to one embodiment of the invention, with the deflector elements in the position for introduction into the vessel.

FIG. 3 is a diagrammatic perspective view of a part of the example of a solid particle distribution device from FIG. 2 with the deflector elements in the position for deviation of particles.

FIG. 4 is a sectional view representing the example of the distribution device from FIGS. 2 and 3.

FIG. 5 is a diagrammatic perspective view of one example of a reactor cover provided with an orifice for the passage of a distribution device according to one embodiment of the invention.

### DETAILED DESCRIPTION OF PARTICULAR EMBODIMENTS

Identical references may be used from one figure to the other to designate identical or similar elements.

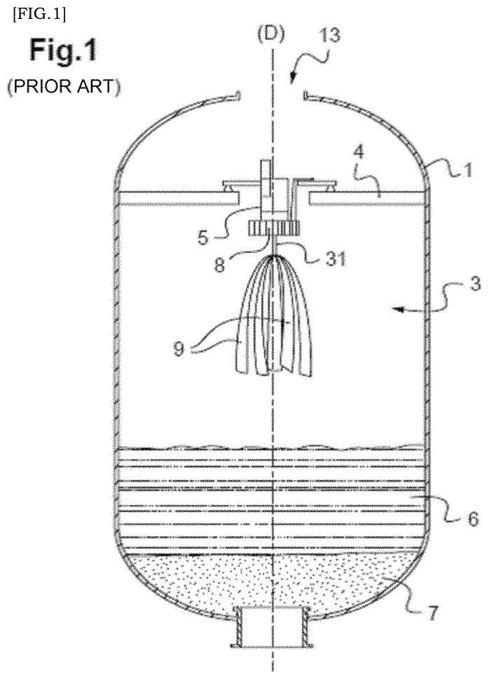

Referring to FIG. 1, a reactor 1 defines an opening 13, referred to as an orifice, for the passage in particular of a device 3 for distribution of solid particles 6, 7.

The distribution device 3 may for example be of the same type as that described in the document WO 2010/076522.

In the example represented the distribution device rests on a plate 4 of the reactor 1 on arms.

The device 3 further includes rigid or semi-rigid straps 9 for better distribution of the solid particles. Each of these straps 9 is fixed by one end to a shaft 31 extending along a vertical axis (D) through a hopper 5 for feeding solid particles.

The orifice 13 must be large enough to allow all the straps 9 to pass through it.

The hopper 5 may be connected to a store of solid particles, not shown, in a manner known in itself.

During loading solid particles flow through openings 8 defined at one end of the hopper, situated above the straps 9.

Also, the shaft 31 is driven in rotation by a motor, not represented, so that the straps extend away from the shaft at an angle.

Particles falling from the hopper 5 are liable to rebound on these straps and thus to be deviated from their trajectory. These somewhat random deviations can enable dense loading of solid particles.

The distribution device 3 enables loading of the reactor 1 with inert balls 6 and also with catalyst particles 7.

By products loaded into the reactor, or loading of the reactor, is meant solid particles distributed into the reactor by the distribution device, for example the beds 6, 7 from FIG. 1, the reagents and products in the chemical sense of the term, and/or otherwise.

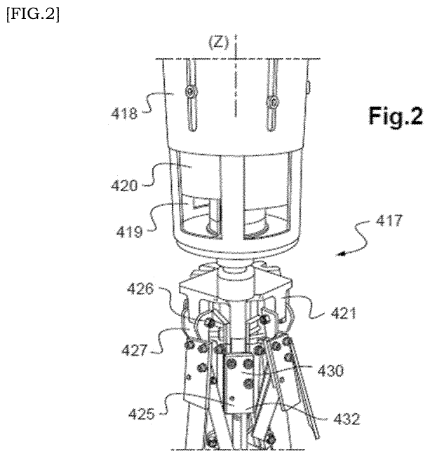

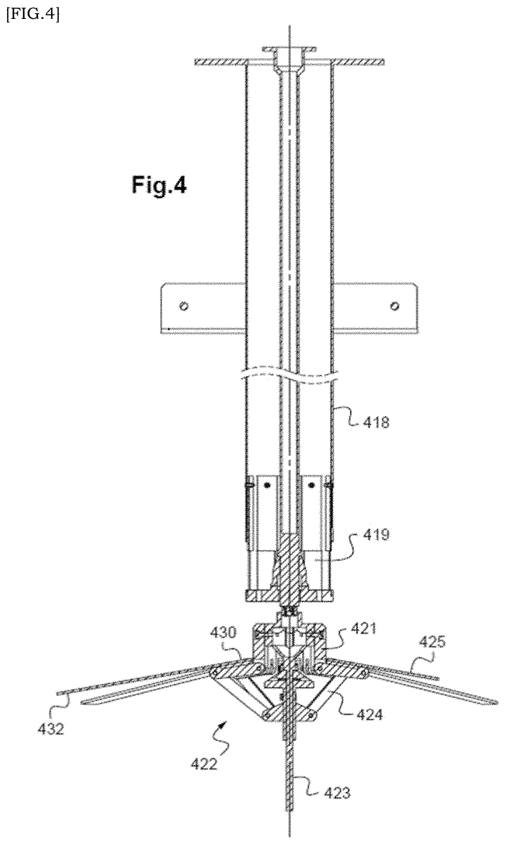

Referring to FIGS. 2, 3 and 4, a distribution device 417 comprises a hopper 418 defining a plurality of, here four, lateral openings 419 defined in the lateral walls of the hopper. The bottom of the hopper is solid with the exception of an opening for the passage of rotating mechanical elements.

In this example each opening 419 is equipped with a blocking flap 420 mounted on and sliding on vertical rails. The effective section of each opening 419 can therefore be adjusted so that the set of openings 419 can be distributed in an asymmetric manner over the periphery of the hopper so as to favor the evacuation of the particles contained in the hopper in certain directions.

Under these openings 419 rigid plastic deflector elements 425 are mounted on a rotating element 421.

That rotating element 421 cooperates via conversion means with no reference symbol with a shaft crossing the hopper positioned in a central manner relative to the hopper and driven in rotation by a motor that is not represented about an axis (z).

These conversion means, comprising in particular a roller, enable transformation of the continuous rotation movement of the shaft into an oscillating movement of the rotating element 421.

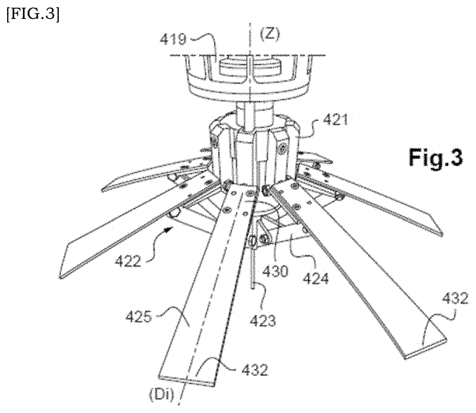

Each deflector element extends longitudinally between a first end 430 and a second end 432, in its own longitudinal direction. There has been represented in FIG. 3 a straight line segment (Di) parallel to the longitudinal direction tied to the deflector element referenced 425.

An articulation 426, 427 at the end 430 of each deflector element 425 defines a pivot connection between that deflector element and the rotating element 421.

The other end 432 is a free end.

To be more precise, two flanges 427 facing one another are fastened by screws to the deflector element. These flanges 427 define orifices to receive a rod 426 passing through a bore defined in the rotating element 421.

Thanks to this pivot connection the deflector elements 425 are therefore able to pass from a position for introduction into the vessel, as shown in FIG. 2, to a deployed position, as shown in FIG. 3.

In this embodiment, this passage from one position to the other is effected by means of a linkage member 422. This member comprises a plurality of rods articulated to one another, including a central vertical rod 423 and radial rods 424.

The radial rods 424 are articulated to the deflector elements 245 and the linkage member 422 is such that a vertical movement of the central rod 423 drives in movement the radial rods 424 and therefore the deflector elements 425, in the manner of an umbrella.

This linkage member, functioning like an umbrella, can enable all of the deflector elements to be erected at the same time.

The deflector elements installed in the vessel may be erected before starting the motor.

The rotation speed has no influence on the angle of the deflector elements. The rotation speed may therefore affect the permeability to particles independently of this angle between the rotation axis and the longitudinal direction tied to a deflector element.

The linkage member may advantageously be conformed so that the angular position of at least one deflector element (for example of all of the deflector elements, or of each deflector element individually) may be adjustable. In the example from FIGS. 2, 3 and 4 the deflector elements have variable lengths so as to give preference to a direction of filling the vessel, this device 417 being intended for eccentric positioning.

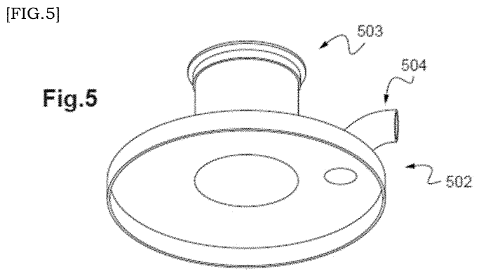

Referring to FIG. 5, there has been represented an example of a cover 502 intended to cover a cylindrical reactor body that is not shown.

This cover 502 defines a small number of, here two, offtakes 503, 504. One offtake 503 corresponds to the passage of the loading device while the other offtake 504 may correspond to an evacuation of air, to the passage of a probe device, etc.

Because of the compactness of the loading device during its introduction into the vessel, it is therefore possible to limit further the nuisance occasioned by dust during loading.

1. A device for distributing solid particles when loading a vessel with said solid particles, comprising:
a solid particle feed hopper defining a set of at least one opening for evacuation of the particles from the hopper by gravity,
a rotating member and a drive member coupled to said rotating member to drive said rotating member in rotation about a rotation axis having under conditions of use a direction with a component in the direction of the gravity vector,
downstream of the set of at least one opening of the feed hopper a set of at least one deflector element, each deflector element extending along its longitudinal direction between a first end and a second end and being carried by said rotating member at its first end,
characterized in that
at least one deflector element of said set is rigid and mounted to pivot on the rotating member at its first end,
the distribution device further comprises remotely actuatable deployment means adapted to drive at least one deflector element mounted to pivot on the rotating member so as to cause it to pivot from a position for introduction into the vessel, in which its longitudinal direction forms a first angle with the direction of the rotation axis, to a particle deviation position, in which its longitudinal direction forms a second angle with the direction of the rotation axis, the second angle being strictly greater than the first angle and imposed by the deployment means independently of the rotation speed of said rotating member.

2. The distribution device of claim 1, in which the distribution device is such that the deployment means are able to retain said at least one deflector element mounted to pivot in at least one intermediate position, each intermediate position corresponding to an angle strictly greater than the first angle and strictly less than the second angle.

3. The distribution device of claim 1, in which the set of at least one deflector element comprises a plurality of deflector elements preferably having different lengths.

4. The distribution device of claim 3, in which the deployment means are conformed to cause one or more deflector elements to pivot independently of the other deflector elements of said plurality.

5. The distribution device of claim 1, in which the second angle is between 45° and 100° inclusive, preferably between 60° and 95° inclusive, and more preferably between 75° and 90° inclusive.

6. The distribution device of claim 1, in which the set of at least one deflector element is distributed in an irregular manner around the rotation axis.

7. The distribution device of claim 6, in which the set of at least one deflector element is such that when erected relative to the rotation axis the projections of said set in a plane normal to the rotation axis of the rotating member have an asymmetric distribution around said rotation axis with at most one plane of symmetry passing through the rotation axis.

8. The distribution device of claim 1, in which the deflector elements are distributed over an angular range from more than 5° to less than 320°, preferably less than 280°, more preferably less than 180° and still better less than 120°.

9. The distribution device of claim 1, in which the deployment means comprise a linkage member comprising a first end rod extending toward the hopper top under conditions of use and at least one second rod mounted on and articulated relative to the first rod and cooperating with at least one deflector element.

10. The distribution device of claim 1, in which the first angle is between 0° and 20° inclusive.

11. The distribution device of claim 1, in which the set of at least one opening of the feed hopper is conformed in an asymmetric manner relative to the rotation axis, defining at most one plane of symmetry passing through the rotation axis.

12. The distribution device of claim 11, in which the drive member is such that the rotating member to which it is coupled effects a movement with angular speed variations over an angular range of 360° or less.

13. A method of installing the solid particle distribution device of claim 1 in a vessel defining an orifice in its upper part, comprising:
causing to pass through said orifice at least the rotating member and the set of at least one deflector element comprising at least one rigid deflector element in a position for introduction into the vessel, and
remotely actuating the deployment means to drive at least one deflector element mounted to pivot on the rotating member so as to cause it to pivot from the position for introduction into the vessel to the position for deviation of the particles.

14. An assembly comprising a vessel, preferably a catalytic reactor, and the device of claim 1 with the rotating member and the set of at least one deflector element introduced into the vessel.

15. A method of loading solid particles into a vessel having an opening in its upper part, comprising:
a) the installation in the vessel of the distribution device of claim 1 via the opening in the upper part of the vessel; then
b) driving in rotation the rotating member of said device; and
c) loading particles by introducing them into the feed hopper of said device whilst maintaining the rotating member in rotation.

16. The method of claim 15, characterized in that the rotating member effects an oscillating movement with the rotation direction reversed at the ends of an angular range extending over 350° or less, preferably 330° or less, more preferably 320° or less, better 310° or less, and even better 270° or less.
